(19) United States
(12) Patent Application Publication
(10) Pub. No.: US 2003/0048292 A1
(43) Pub. Date: Mar. 13, 2003

(54) Method and apparatus for displaying information

(76) Inventors: Michael John Branson, Rochester, MN (US); Kenneth Edgar Brown, Rochester, MN (US); Steven Gene Halverson, Rochester, MN (US); Gregory Richard Hintermeister, Rochester, MN (US)

Correspondence Address: Gero G. McClellan, Moser, Patterson & Sheridan, L.L.P., Suite 1500, 3040 Post Oak Boulevard, Houston, TX, 77056-6582, US

(21) Appl. No.: 09/951,264

(22) Filed: Sep. 13, 2001

(51) Int. Cl. G06F 3/00; G06F 13/00

(52) U.S. Cl. 345/736

(57) ABSTRACT

Embodiments provide a method, article of manufacture, and apparatus for simultaneously displaying on handheld display devices the top-level status of network objects such as network devices, systems, firmware, etc. In one embodiment, the user can drill-down from a top-level status to determine sub-status information for the monitored network objects. In another embodiment, the user can select the network objects to monitor and display summarized status information pertaining to the selected network objects.

### BACKGROUND OF THE INVENTION

1. Field of the Invention

Embodiments of the invention generally relate to displaying information. More particularly, the invention relates to displaying information on portable devices having limited display capacity.

2. Background of the Related Art

With the advent of distributed data processing, distributed systems have become increasingly used to facilitate communication, data processing, etc., within a group of computing devices. Generally, in a distributed computing environment, an end-user e.g., a client computer is coupled to a localized system of computers such as a local area network (LAN) to a server that in turn may be connected to other servers locally or remotely. For example, a geographically distributed business enterprise may maintain several interconnected LANs at each of its geographically separate offices. The LAN servers at a given office location are then interconnected over wide area networks (WANS) to the servers in the remote offices. An example of one such large distributed network is the Internet. The complex interconnected networks and devices characterizing this distributed computing model facilitates redundant interconnection of mission-critical applications and data on high-bandwidth servers, to less important applications and data assigned to correspondingly lower-end servers.

To avoid system wide failures, the distributed system typically is incorporated with features and redundancy that ensure that the system will continue to operate properly and will continue to be available notwithstanding the failure or maintenance of a single system or device. To monitor and maintain the operability of network systems, devices, and processes, businesses have increasingly adopted a centralized monitoring system whereby a network operator or “network administrator” will use various types of displays and graphical user interfaces (GUI), etc., to monitor the various network devices, tasks, jobs, etc. Monitoring systems generally provide a user with complex and dynamic reports of system and device status throughout the network or networks. The network status information is often displayed with a rich graphical interface to the user and is often continually updated. The monitoring systems often provide an interactive ability to further “drill-down” allowing the user to expand and scroll through the information pertaining to a specific system, device, job, etc. However, as networks become geographically separated, monitoring and maintaining such systems increases in complexity. For example, the network administrator may be required to monitor and/or repair multiple devices, processes, jobs, etc. across multiple systems and platforms, often dispersed over large geographic areas. Therefore, while implementation of distributed computing model offers numerous advantages for end-users, it presents correspondingly complex network management issues for network administrators.

Generally, to maintain and/or repair a geographically dispersed network, one or more technicians trained to diagnose and repair network components and systems are often employed to repair a network system at a particular geographic location. To test, calibrate, and repair, a network device and/or system often requires the use of local monitoring equipment designed to give the technician the proper status and diagnostic information at the location of interest. Generally, the technician can log onto a localized network computer to diagnose the system status from virtually any monitoring system within the local network. Unfortunately, for some remote locations, the technician does not have access to the correct type of monitoring equipment and/or the use of such equipment is cumbersome. Typically, for convenience, technicians will carry their own monitoring equipment to each location. For example, a convenient wireless handheld monitoring system (e.g., handheld display device) may be carried by the technician to diagnose network problems in remote locations. Unfortunately, while handheld monitoring devices are portable, they generally must be configured to display information for each network device or system. Therefore, to monitor multiple numbers of network system, and components, several monitoring devices must be used, or re-configured, by the technician, thereby increasing the system diagnostic time and maintenance costs. In addition, as wireless devices often have small information input/output capacity, the time required to download the system status and diagnostic information may be inordinate. For example, currently many wireless handheld devices can only send and receive information at slower modem speeds such as 9,600 baud. Therefore, a large file or complex GUI may take several seconds to several hours to download. Further, the display size for a typical display device such as a personal digital assistant (PDA) or cellular telephone is extremely limited causing the technician to scroll through line after line of text to find the pertinent data. For example, the display size of a cellular phone generally supports only about two to four lines of about 15 characters each. Additionally, a PDA may only allow about 50 characters of data displayed at a time and virtually no capacity for an image to be displayed. Therefore, to analyze a device status having 400 characters requires the technician to scroll through at least six lines of characters to determine the status of a single device. This issue is further compounded when the technician tries to display and diagnose a plurality of network devices.

Therefore, there is a need for a status monitoring method and apparatus to efficiently display network information on a handheld display device pertaining to a plurality of network devices and processes.

### SUMMARY OF THE INVENTION

Embodiments of the invention provide a method, article of manufacture, and apparatus for displaying information on devices in a manner that facilitates simultaneously assessing the status of a multitude network objects. In one embodiment, the invention provides a method of displaying network object status information comprising receiving network object status information associated with a plurality of network objects, wherein the network object status information includes a top-level status descriptor associated with a plurality of sub-level status descriptors, and then displaying only the top-level status descriptor on a display device.

In another embodiment, the invention provides a method of processing network object status information at a processing system for the purpose of subsequently displaying information on a display device. The method includes receiving, from a display device, a request for network object status information, retrieving network object status information associated with a plurality of network objects wherein the network object status information includes a top-level status descriptor indicative of the top-level status of a plurality of sub-level status descriptors, and transmitting only the top-level status descriptor to a display device.

In still another embodiment, the invention provides a computer-readable medium containing an information control program which, when executed by a processor, performs operations including receiving, from a display device, a request for network object status information, retrieving network object status information associated with a plurality of network objects wherein the network object status information includes a top-level status descriptor indicative of the top-level status of a plurality of sub-level status descriptors, and transmitting only the top-level status descriptor to the display device.

In another embodiment, the invention provides a processing system comprising a memory and an input device coupled to a plurality of network objects. The memory contains at least a database comprising a list of network object statuses associated with the plurality of network objects and an information control program which, when executed by a processor, is configured to organize the list of network object statuses into a top-level status descriptor and a plurality of sub-level status descriptors.

### BRIEF DESCRIPTION OF THE DRAWINGS

So that the manner in which the above recited features and embodiments can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a distributed data processing system.

FIG. 2 depicts a memory core for storing programming data.

FIG. 3 illustrates a network object data structure that includes a list of network object statuses.

FIG. 4 illustrates a data structure related to drill-down information pertaining to serial and/or parallel connected network objects.

FIG. 5 illustrates a data structure related to a selected number of network objects within the network object data structure of FIG. 3.

FIG. 6 illustrates a data structure related to the precedence of status descriptors.

FIG. 7 is a diagrammatic view illustrating a display screen displaying status descriptors related to network objects.

FIG. 8 is a diagrammatic view illustrating a display screen displaying status descriptors related to network objects.

FIG. 9 is a diagrammatic view illustrating a display screen displaying a sub-level status descriptor related to a network object and associated sub-level network objects.

FIGS. 10A and 10B depict a flow diagram of a method for establishing a status descriptor display in accordance with aspects of the invention.

### DETAILED DESCRIPTION OF THE PREFERRED EMBODIMENTS

Embodiments of the invention provide a method, article of manufacture, and apparatus for displaying information to facilitate simultaneously assessing the status of a multitude network objects. As used herein “information” includes any data or values regardless of format, or length. A value may be a single character (e.g., letter, numeral, symbol, etc.) or may be a string of characters (e.g., a phrase). As used herein “pre-defined status” means that a fixed/static association between network objects and data/values exist. In particular, “pre-defined,” indicates that the association exists before receiving network object status. In addition, as used herein, term network object includes network systems and network elements such as network device hardware, software, protocols, actions, information, jobs, processes, and the like, used with one or more distributed data processing systems. Further, as used herein a “top-level status descriptor” is defined as being indicative of an overall status descriptor representing a plurality of status descriptors.

As will be described below, aspects of one embodiment pertain to specific method steps implementable on computer systems. In one embodiment, the invention may be implemented as a computer program-product for use with a computer system. The programs defining the functions of at least one embodiment can be provided to a computer via a variety of computer-readable media (i.e., signal-bearing medium), which include but are not limited to, (i) information permanently stored on non-writable storage media (e.g. read-only memory devices within a computer such as read only CD-ROM disks readable by a CD-ROM or DVD drive; (ii) alterable information stored on a writable storage media (e.g. floppy disks within diskette drive or hard-disk drive); or (iii) information conveyed to a computer by communications medium, such as through a computer or telephone network, including wireless communication. The latter specifically includes information conveyed via the Internet. Such signal-bearing media, when carrying computer-readable instructions that direct the functions of the invention, represent alternative embodiments of the invention. It may also be noted that portions of the product program may be developed and implemented independently, but when combined together are embodiments of the invention.

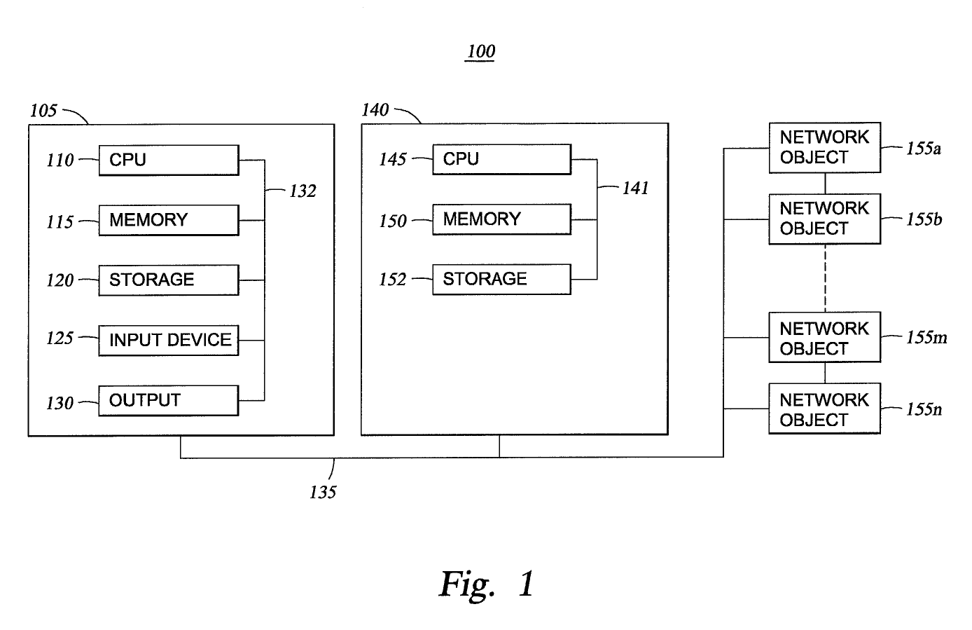

FIG. 1 depicts one embodiment of a distributed data processing system 100. In general, the distributed data processing system 100 includes a server computer 140 adapted to connect to one or more network objects 155A-N and one or more display devices 105 over a network. The display device 105 represents any hardware/firmware device such as computers, personal digital assistants (PDAs), mobile phones, pagers, and the like having limited display screen sizes and display capabilities and adapted to communicate with the server computer 140. For example, display device 105 may be a cellular phone having only two lines of characters to display information. The network objects 155A-N and display device 105 are coupled to the server computer 140 via a network bus connection 135 such as telephone wires, cables, twisted pair, wireless connections, and others, adapted to provide a two-way network communication connection. Illustratively, the display device 105 includes a Central Processing Unit (CPU) 110 connected via a bus 132 to a memory 115, storage 120, input device 125, and output device 130. The input device 125 can be any device adapted to give input to the display device 105. For example, a keyboard, keypad, light-pen, touch-screen, track-ball, or speech recognition unit could be used. The output device 130 is preferably any conventional display screen. In a particular embodiment, the output device is a display screen of limited area, such as a display screen used on portable handheld devices. Although shown separately from the input device 125, the output device 130 and input device 125 could be combined. For example, a display screen with an integrated touch-screen, and a display with an integrated keyboard, or a speech recognition unit combined with a text speech converter could be used. Storage 120 is preferably a direct access storage device (DASD), although it is shown as a single unit, it could be a combination of fixed and/or removable storage devices, such as fixed disc drives, floppy disc drives, tape drives, removable memory cards, or optical storage. Memory 115 and storage 120 could be part of one virtual address space spanning multiple primary and secondary storage devices. While memory 115 is shown as a single entity, it should be understood that memory 115 may in fact comprise a plurality of modules, and that memory 115 may exist at multiple levels, from high speed registers and caches to lower speed but larger DRAM chips.

The server computer 140 generally comprises a CPU 145, a server memory 150, and a storage device 152, coupled to one another by a bus 141. Server memory 150 is a random access memory (i.e., RAM) sufficiently large to hold the necessary programming and data structures that are located on the server computer 140. Server memory 150 and the storage device 152 could be part of one virtual address space spanning multiple primary and secondary storage devices. While server memory 150 is shown as a single entity, it should be understood that server memory 150 may in fact comprise a plurality of modules, and that server memory 150 may exist at multiple levels, from high speed registers and caches to lower speed but larger DRAM chips.

FIG. 1 is merely one configuration for a distributed data processing system 100. Embodiments of the invention can apply to any comparable configuration, regardless of whether the distributed data processing system 100 is a complicated multi-user apparatus, a single-user workstation, or a network appliance that does not have non-volatile storage of its own.

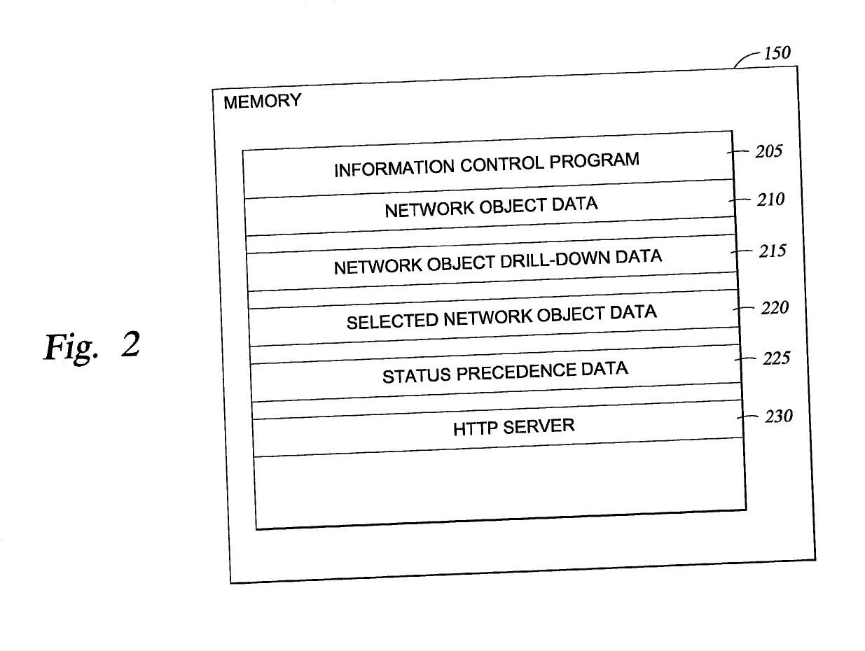

FIG. 2 depicts one embodiment of the server memory 150 for storing programming and data. FIG. 1 is referenced within the following discussion of FIG. 2 as is necessary.

Server memory 150 includes various data structures and programs used to facilitate the operation and configuration of a server computer 140. The programming and data structures may be accessed and executed by the CPU 142 as needed during operation. In one embodiment, the server memory 150 is shown containing an information control program 205 adapted to receive and process status data from a plurality of network objects 155A-N. The information control program 205 includes information that is accessible to the user using commands inputted by characters and phrases entered such as alpha-numeric characters, phrases, voice commands, and the like through any monitoring system coupled to the network such as the display device 105. The server memory 150 includes network object data structure 210 that includes one or more network object status descriptors having a pre-defined status meaning for each network object 155A-N. The server memory 150 also includes network object drill-down data 215 that includes information pertaining to a pre-defined interconnection association between sub-level network objects such as sub-level devices, jobs, processes, etc. and the network objects 155A-N. Further, the server memory 150 includes a list of selected network objects 220 defining a user-selected number of network objects 155A-N to monitor. It is contemplated that the selected network object list 220 may contain all or a portion of the available network objects 155A-N from the network object data structure 210. The server memory 140 includes a status precedence data structure 225 used by the information control program 205 to determine top-level and sub-level status descriptors associated with the overall and/or individual status of the network objects 155A-N. In one aspect, the server memory 150 includes a hypertext transfer protocol (http) server process 230 adapted to run the information control program 205 using network protocol programs such as servlets to service requests from the network objects 15A-N and the display device 105. For example, the information control program 205 may be a servlet program adapted to respond to requests from the display device 105 to retrieve network object status information from the network objects 155A-N. The http server process 230 is merely illustrative and other embodiments adapted to support any known and unknown protocols are contemplated.

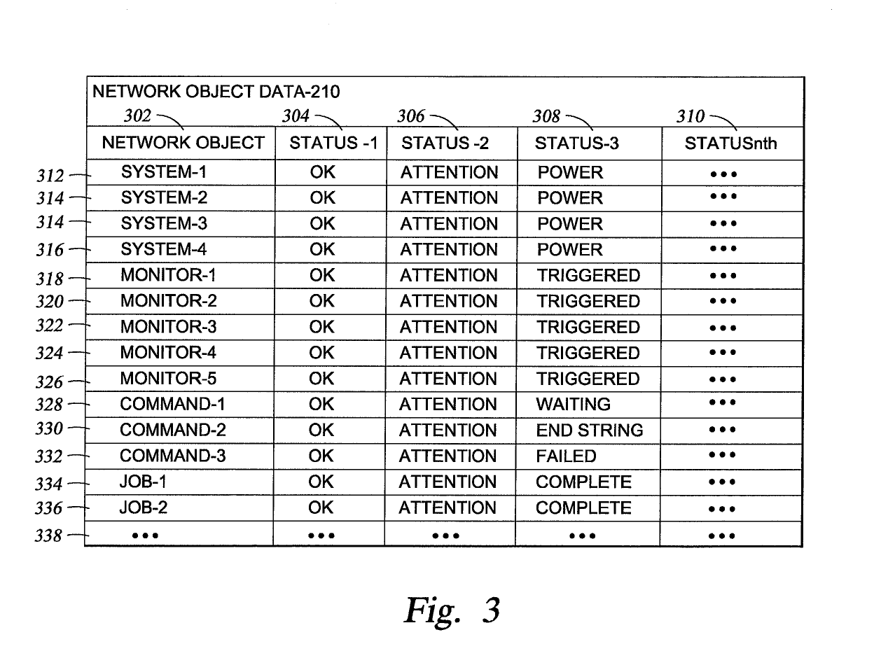

FIGS. 3-6 depict embodiments of the data structures within the server memory 150 for storing data such as network object status information in which aspects of the invention may be used to advantage. FIGS. 1-2 are referenced within the following discussion of FIGS. 3-6 as is necessary.

FIG. 3 illustrates one embodiment of the network object data structure 210. A plurality of network object status descriptors are stored in the network object data structure 210. Each row 312-338 includes the status descriptors associated with one network object. Illustratively, the network object data structure 210 includes a first status descriptor column 304, a second status descriptor column 306, a third status descriptor column 308, and a nth status descriptor column 310 illustrating an nth number of status descriptors associated with a network object 155A-N. For example, from row 312, the network object SYSTEM-1 has associated status descriptors OK, ATTENTION, and POWER, from columns 304-308, respectively.

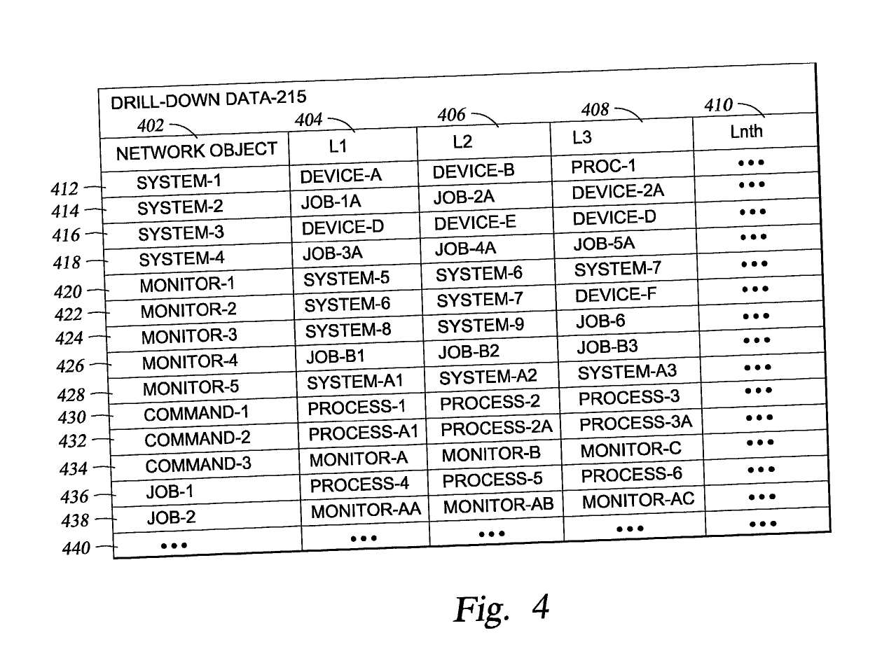

FIG. 4 illustrates one embodiment of the drill-down data structure 215. A plurality of pre-defined sub-level network object associations are stored in the drill-down data structure 215. Each row 412-440 illustrates an association between one network object 155A-N and a plurality of sub-level network objects. Illustratively, the drill-down data structure 215 includes a first level network object column 402, a second level network object column 404, a third level network object column 406, a fourth level network object column 408, and a nth level network object column 410 illustrating an nth number of associations between a network object 155A-N and sub-level network objects. In one aspect, the network object columns 402-410 represent a serial sub-level association whereby each column 402-410 represents a serial connection hierarchy. For example, SYSTEM-1 is connected to DEVICE-A, DEVICE-B is connected to DEVICE-A, PROCESS-1 is coupled to DEVICE-B, and so on. It is contemplated that there may be a parallel association whereby more than one sub-level network object is associated to a network object 155A-N at the same level. For example, DEVICE-A, DEVICE-B, and PROCESS-1 from columns 404-408, respectively, may be coupled directly i.e., in parallel, to SYSTEM-1. Thus, a plurality of sub-network objects may be interconnected in series and/or in parallel to one network object 155A-N.

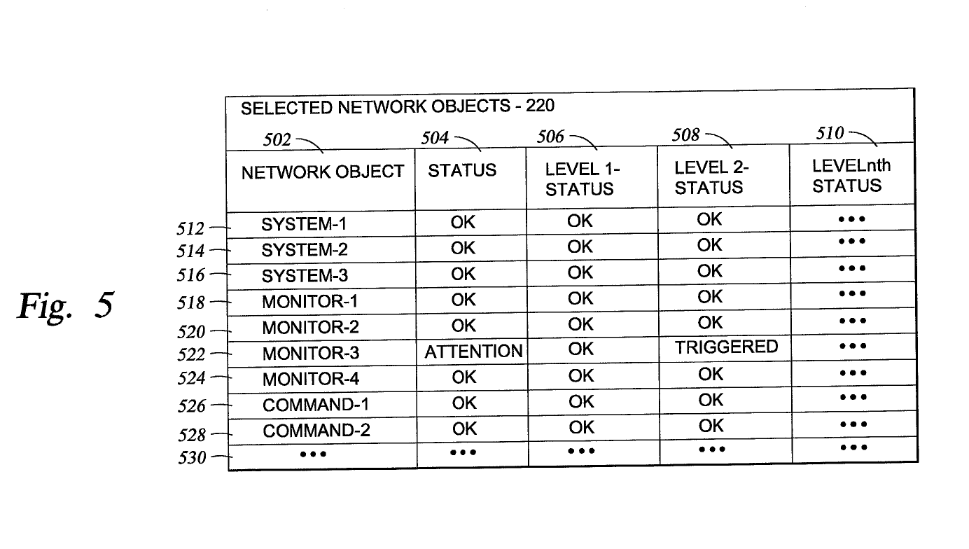

FIG. 5 illustrates one embodiment of a list of statuses for selected network objects 220. A plurality of network objects 155A-N and associated status descriptors are contained within the selected network objects data structure 220. Each row 512-530 illustrates the status of a network object 155A-N with respect to the statuses of its associated serial and/or parallel sub-level network objects. Illustratively, the list of statuses for selected network objects 220 includes a network object column 502 defining the list of network objects 155A-N being monitored, a status descriptor column 504 including status descriptors illustrating the overall status for the network objects 155A-N, and a first, second and third sub-level status columns 506-510 illustrating the status of the first, second, and third, sub-level network object, respectively, from the drill-down data structure 215. For example, from row 512, SYSTEM-1 indicates a status of OK from column 504, indicative that all of its sub-level statuses are OK. However, column 522 has a status descriptor of ATTENTION in column 504, and OK in column 506, and a TRIGGERED in column 508 indicative that there is an issue with an associated sub-level network object at level 2 (i.e., column 508).

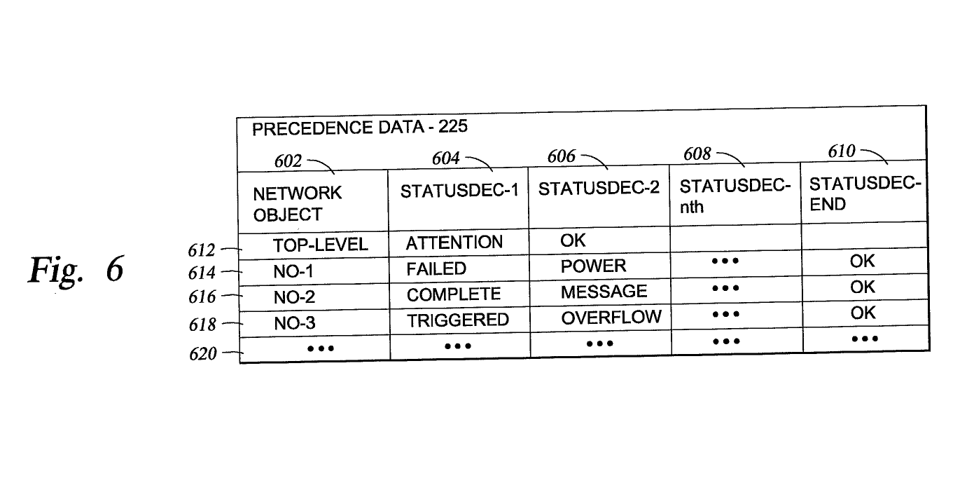

FIG. 6 illustrates one embodiment of a status precedence data structure 225. The status precedence data structure 225 is used by the information control program 205 to establish a top-level status descriptor and associated sub-level status descriptors for the network objects 155A-N. Illustratively, each row 612-620 includes a list of network objects 155A-N and an associated hierarchy of status descriptors. In one aspect, column 602 defines the list of available or selected network objects 155A-N. The STATUSDEC-1, STATUSDEC-2, and STATUSDEC-3 columns 604-610 represent the hierarchy of each status descriptor from highest to lowest. For example, the STATUS-1 column 604 represents the highest status whereas the STATUSDEC-END represents the lowest precedence status descriptor, respectively. Further, the STATUSDECnth illustrates an nth number of status descriptors. While the status descriptor OK is illustrated as the lowest precedence status descriptor, it is contemplated that any status descriptor may be selected as the lowest descriptor precedence value.

FIGS. 7-9 depict embodiments of an output display of the display device 105 in which aspects of the invention may be used to advantage. FIGS. 1-6 are referenced within the following discussion of FIGS. 7-9 as is necessary.

FIG. 7 illustrates one embodiment of a status display screen 700 used to display the top-level and sub-level status descriptors for a plurality of network objects 155A-N. In one aspect, the display screen 700 is integral to the display device 105. As illustrated in FIG. 7, the display screen 700 is used to display a top-level status descriptor 715A, and sub-level status descriptors 720, 725, and 730, respectively, representing the status of the overall plurality of network objects 155A-N being monitored and the status of selected sub-level network objects from the selected network objects data structure 220. For example, the top-level status descriptor 715A is displaying an “OK”, indicating that the overall status of the plurality of network objects being monitored is normal. In one aspect, to allow a user to not have to scroll down, the top-level status descriptor 715A represents the summary status of what is on the display 700. For example, the top-level status descriptor 715A as illustrated represents the status of nine network objects being monitored. The sub-level status descriptor 720 displays the status for three systems, the sub-level status descriptor 725 displays the status for four monitors, and the sub-level status descriptor 730 displays two commands being monitored.

FIG. 8 illustrates one embodiment where the top-level status descriptor indicates the top-level descriptor 715B and sub-level status descriptors 720-730 are indicative of one or more status changes within the plurality of network objects155A-N. For example, the top-level status descriptor 715B includes the status descriptor “*ATTENTION*” indicative of a status change and/or issue with the plurality of network objects 155A-N. In one aspect, the sub-level status descriptor 725, includes an asterisk “*”, to associate the word “ATTENTION” to the network objects 155A-N that represent monitors.

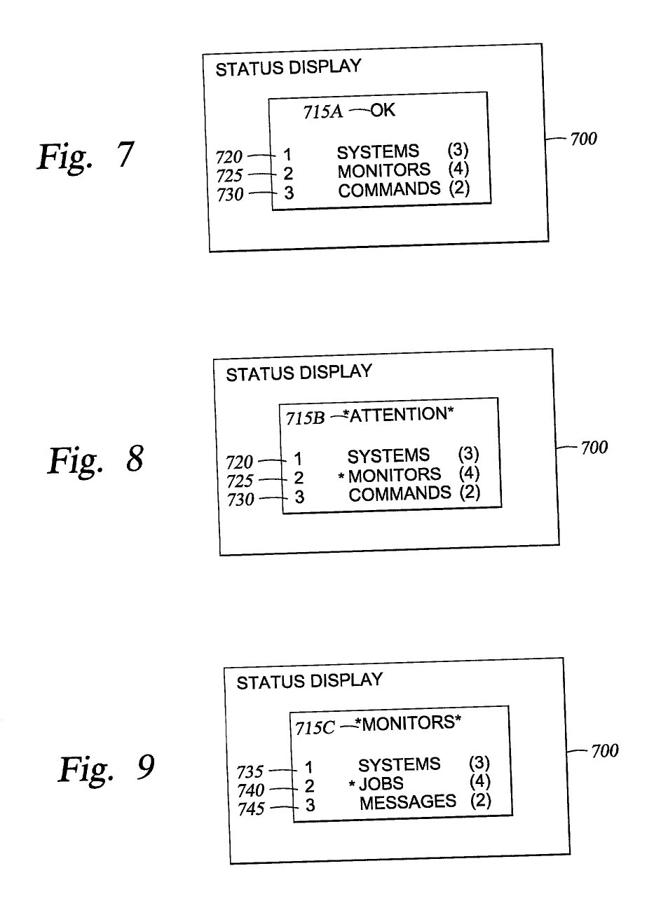

FIG. 9 illustrates a drill-down from FIG. 8 whereby when the monitor sub-level status descriptor 725 is selected, the top-level status descriptor 715B and associated sub-level descriptors 720-730 are replaced with the top-level status descriptor 715C and associated sub-level descriptors 735-745, respectively. For example, when the sub-level monitor descriptor 725 is selected, the top-level status descriptor 715A is changed from “*ATTENTION*” 715B, to “*MONITORS*” 715C, and the associated systems sub-level descriptors 720-730 are changed to a monitor system descriptor 735, jobs descriptor 740, and message descriptor 745, respectively. Thus, the user may drill-down from a top-level status descriptor 715A to determine the status of one or more sub-level status descriptors. In one aspect, the top-level status descriptor 715C may be adapted to display additional information pertaining to the sub-level status descriptors to aid the user in determining which level(s) to focus their attention. For example, the top-level status descriptor 715C may be indicate “*MONITORS*” and on the next line indicate “system monitors” to indicate that the system monitors are normal and that another monitor type needs attention. Thus, the user can expedite the drill-down process by drilling-down to the other monitor types ignoring the system monitors.

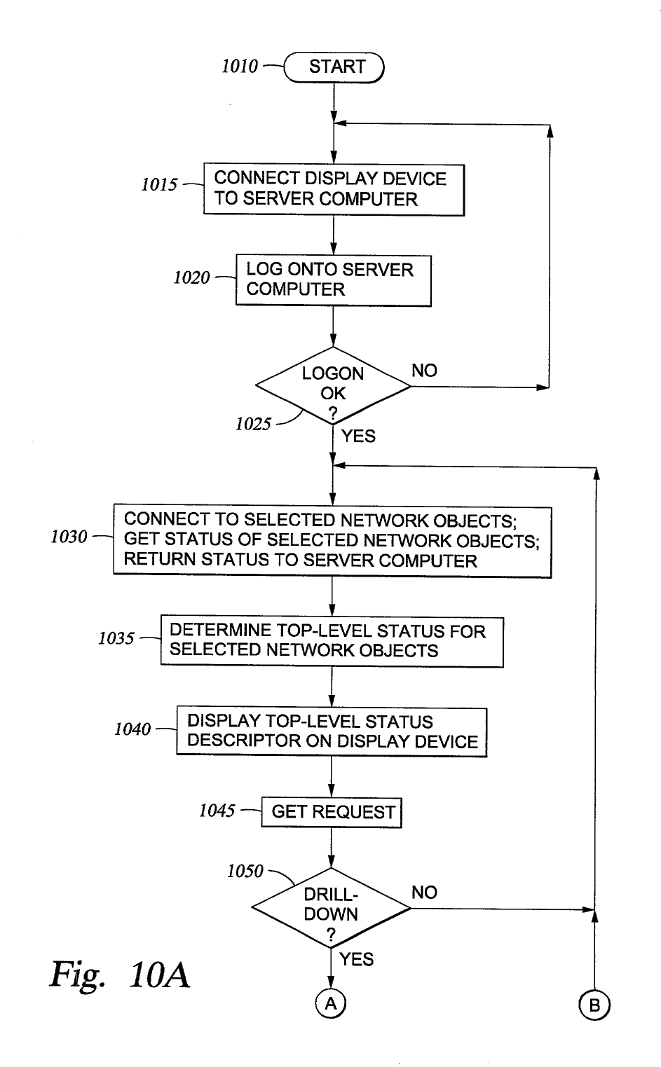

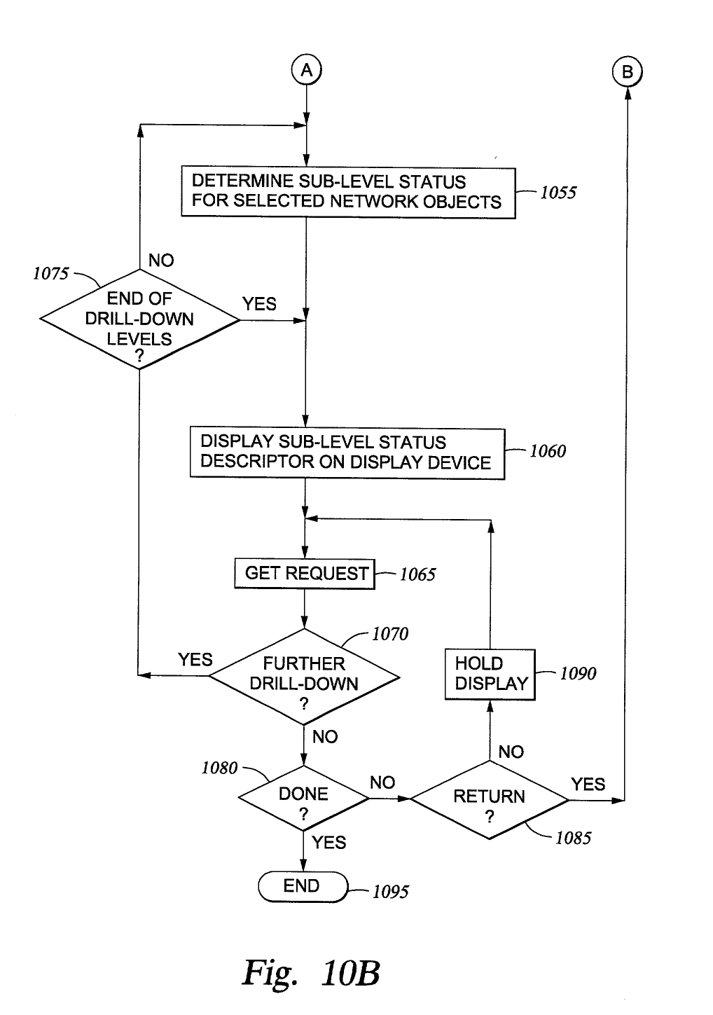

FIGS. 10A and 10B depict a flow diagram of a method 1000 for implementing an information control program 205. The particular steps and sequence of steps are merely illustrative and other embodiments are contemplated. As necessary, FIGS. 1-9 are referenced in the following discussion of FIG. 10.

FIG. 10 is entered into at step 1010 when, for example, the display device 105 requests to display the top-level and sub-level status descriptors for a plurality of network objects 155A-N. At step 1015, the method 1000 establishes communication between the display device 105 and the server computer 140. At step 1020, the method 1000 logs the display device 105 into the server computer 140. At step 1025, the method 1000 determines whether the display device 105 has successfully logged onto the server computer 140. If the display device 105 has not logged on successfully, the method 1000 returns to step 1015 to reconnect to the server computer 140. In one aspect, if after a predetermined number of logon attempts, the display device 105 is unable to log on to the server computer 140, an alert will be sent to the display device 105 indicative of the logon failure. If the display device 105 has logged on successfully, the method 1000 proceeds to step 1030. At step 1030, the method 1000 returns the status of the plurality of network objects 155A-N to the server computer 140. At step 1035, the method 700 determines the top-level and sub-level status descriptors of the selected network-objects 155A-N by comparing the statuses received to the status precedence data structure 225. At step 1040, the method 700 transmits one top-level status descriptor and associated sub-level status descriptors to the display device 105. In another embodiment, only the top-level descriptor is transmitted to the device. The sub-level descriptors are then sent upon explicit requests from the display device. In this manner, devices with limited bandwidth are not overburdened with large amounts of data and data is provided on an as-needed basis. Subsequently, the display device displays the top-level status descriptor and selected sub-level status descriptors.

At step 1045, method 700 gets a request from the display device 105. At step 1050, the method 1000 determines if the request is to drill-down. If the request is not to drill-down, the method 1000 returns to step 1030. If the request is to drill-down, then method 1000 proceeds to step 1055. At step 1055, the method 1000 determines the top-level status descriptor and associated sub-level status descriptors for the network object 155A-N selected. At step 1060, the method 1000 transmits the top-level status descriptor and sub-level status descriptors to the display device 105 that subsequently displays the top-level and sub-level status descriptors. At step 1065, the method 1000 receives the next request from the display device 105. At step 1070, the method 1000 determines if the request is to drill-down to the next sub-level. If the user has not requested to drill-down to the next level, the method 1000 proceeds to 1080 described below. If the request is to drill-down further, then method proceeds to step 1075 to check if the last sub-level has been reached. If the last sub-level has been reached, then method 1000 proceeds to step 1060. If the last level has not been reached, then the method 1000 proceeds to step 1055. If at step 1070 the request was not to drill-down further, the method 1000 proceeds to step 1080. At step 1080, the method 1000 checks to see if the request is to end the session. If the request is to end the session, then the method 1000 proceeds to step 1095 and ends. If the request is not to end the session, the method 1000 proceeds to step 1085 to see if the request is to return to the top-level status. If the request is to return to the top-level status then the method proceeds to step 1030. If however the request was not to return, then the method 1000 proceeds to step 1090, holds the display on the display device 105, and subsequently proceeds to step 1065 to await the next request. Thus, a user can view the top-level status, select the network object 155A-N to monitor, and continue to drill-down to each sub-level to investigate the status of the sub-level network objects as desired.

Although various embodiments which incorporate the teachings of the invention have been shown and described in detail herein, those skilled in the art can readily devise many other varied embodiments within the scope of the invention. For example, while an asterisk “*” may be used to denote an association between the top-level status descriptor and a sub-level status descriptor, it is contemplated that any character or symbol, or action such as blinking, may be used to denote a pre-defined association.

While the foregoing is directed to the preferred embodiment of the invention, other and further embodiments of the invention may be devised without departing from the basic scope thereof, and the scope thereof is determined by the claims that follow.

What is claimed is:

1. A method of displaying network object status information, comprising:
receiving network object status information associated with a plurality of network objects wherein the network object status information comprises a top-level status descriptor associated with a plurality of sub-level status descriptors, wherein the top-level status descriptor is a composite representation of the sub-level status descriptors; and
displaying the top-level status descriptor on a display of a device without displaying the plurality of sub-level status descriptors.

2. The method of claim 1, wherein the network objects comprise network device hardware, software, protocols, actions, information, jobs, processes, and combinations thereof.

3. The method of claim 1, wherein the top-level status descriptor and sub-level status descriptors comprise characters selected from letters, numerals, symbols, phrases, images, and combinations thereof.

4. The method of claim 1, wherein the device is a portable device comprising one of a portable computer, a personal digital assistant, a mobile telephone, a pager and combinations thereof.

5. The method of claim 1, wherein the network object information is received, in response to a request issued from the device, from a remote processing system configured to process the network object information.

6. The method of claim 1, wherein receiving network object information comprises receiving only the top-level status descriptor for the plurality of network objects; and wherein the top-level status descriptor is indicative of a composite status for the plurality of network objects.

7. The method of claim 1, wherein receiving network object status information comprises receiving only the top-level status descriptor for the plurality of network objects.

8. The method of claim 7, further comprising receiving the sub-level status descriptors associated with the plurality of network objects.

9. The method of claim 8, wherein the sub-level status descriptors are received in response to a user prompt to drill down from the displayed top-level status descriptor.

10. The method of claim 1, wherein the top-level status descriptor is indicative of a composite status for the plurality of network objects.

11. The method of claim 10, further comprising drilling down from the top-level status descriptor to display at least one of the plurality of sub-status descriptors wherein each of the sub-status descriptors is indicative of a status for one network object.

12. A method of processing network object status information at a processing system for the purpose of subsequently displaying information on a display device, comprising:
receiving, from a display device, a request for network object status information;
retrieving network object status information associated with a plurality of network objects wherein the network object status information comprises a top-level status descriptor indicative of the top-level status of a plurality of sub-level status descriptors, wherein the top-level status descriptor is a composite representation of the sub-level status descriptors; and
transmitting the top-level status descriptor to a display device for display on the display device without the plurality of sub-level status descriptors.

13. The method of claim 12, wherein the network objects comprise network device hardware, software, protocols, actions, information, jobs, processes, and combinations thereof.

14. The method of claim 12, wherein the top-level status descriptor is indicative of a composite status for all of the network objects.

15. The method of claim 12, wherein each sub-level status descriptor is indicative of a status for one network object.

16. The method of claim 12, further comprising:
receiving, from the display device, a request for the plurality of sub-level status descriptors; and
transmitting the plurality of sub-level status descriptors for display on the display device.

17. The method of claim 16, wherein the request for the plurality of sub-level status descriptors is transmitted from the display device upon a user-input drill down command with respect to the top-level status descriptor displayed on the display device.

18. The method of claim 12, further comprising, prior to the step of transmitting, determining the top-level status descriptor, wherein determining the top-level status descriptor comprises determining a precedence of the sub-level status descriptors and establishing a highest precedence sub-level status descriptor as the top-level status descriptor.

19. The method of claim 18, determining the precedence of the sub-level status descriptors comprises comparing a plurality of precedence values associated with each sub-level status descriptor.

20. A computer-readable medium comprising an information control program, wherein the information control program, when executed by a processor performs operations comprising:
receiving, from a display device, a request for network object status information;
retrieving network object status information associated with a plurality of network objects wherein the network object status information comprises a top-level status descriptor indicative of the top-level status of a plurality of sub-level status descriptors, wherein the top-level status descriptor is a composite representation of the sub-level status descriptors; and
transmitting only the top-level status descriptor to the display device.

21. The computer-readable medium of claim 20, wherein the network objects comprise network device hardware, software, protocols, actions, information, jobs, processes, and combinations thereof.

22. The computer-readable medium of claim 20, wherein the top-level status descriptor is indicative of a composite status for all of the network objects.

23. The computer-readable medium of claim 20, wherein each sub-level status descriptor is indicative of a status for one network object.

24. The computer-readable medium of claim 20, further comprising, prior to the step of transmitting, determining the top-level status descriptor, wherein determining the top-level status descriptor comprises determining a precedence of the sub-level status descriptors and establishing a highest precedence sub-level status descriptor as the top-level status descriptor.

25. The computer-readable medium of claim 24, wherein determining the precedence of the sub-level status descriptors comprises comparing a plurality of precedence values associated with each sub-level status descriptor.

26. A processing system, comprising:
an input device coupled to a plurality of network objects;
a memory containing at least an information control program and a database comprising a list of network object statuses associated with the plurality of network objects; and
a processor which, when executing the information control program, is configured to organize the list of network object statuses into a top-level status descriptor and a plurality of sub-level status descriptors, wherein the top-level status descriptor is a composite representation of the sub-level status descriptors.

27. The processing system of claim 26, wherein the list of network object statuses comprises a plurality of statuses each indicative of a status of a network object of the plurality of network objects.

28. The processing system of claim 26, wherein the list of network object statuses comprises one status indicative of a top-level status for all of the plurality of network objects, wherein the top-level status is represented by the top-level status descriptor.

29. The processing system of claim 26, wherein the database comprises a precedence data array to establish a hierarchy of the list of network object statuses.
